(19) United States
(12) Patent Application Publication
(10) Pub. No.: US 2015/0178436 A1
(43) Pub. Date: Jun. 25, 2015

(54) CLOCK ASSIGNMENTS FOR PROGRAMMABLE LOGIC DEVICE

(71) Applicant: LATTICE SEMICONDUCTOR CORPORATION, HILLSBORO, OR (US)

(72) Inventors: CHIH-CHUNG CHEN, PALO ALTO, CA (US); JUN ZHAO, FREMONT, CA (US); YINAN SHEN, SUNNYVALE, CA (US)

(73) Assignee: LATTICE SEMICONDUCTOR CORPORATION, HILLSBORO, OR (US)

(21) Appl. No.: 14/136,482

(22) Filed: Dec. 20, 2013

(51) Int. Cl. G06F 17/50

(52) U.S. Cl. CPC G06F 17/5081; G06F 17/5072

(57) ABSTRACT

Various techniques are provided to perform clock assignments in a programmable logic device (PLD). In one example, a computer-implemented method includes receiving a design identifying operations to be performed by a programmable logic device (PLD), synthesizing the design into a plurality of components of the PLD configured to perform the operations, and performing a simulated annealing process to determine a layout of the components in the PLD based on a system cost including a clock assignment cost for global clock signals of the PLD. Additional methods, systems, machine-readable mediums, and other techniques are also provided.

### TECHNICAL FIELD

The present invention relates generally to programmable logic devices and, more particularly, to clock assignments in such devices.

### BACKGROUND

Programmable logic devices (PLDs) (e.g., field programmable gate arrays (FPGAs)), complex programmable logic devices (CPLDs), field programmable system on a chips (FPSCs), or other types of programmable devices) generally include a finite number of clocks that may be assigned to various components of the PLDs. However, with the growing size of PLDs, the average number of clocks in modern circuit designs has increased along with the density and complexity of such designs. As such, traditional approaches used to assign clocks are often cumbersome and impractical to use with modern PLDs.

For example, in some conventional approaches, clocks are assigned manually by a user with the goal of limiting the number of clock signals in various regions of the PLD, such that the number of clock signals in each region does not exceed device limitations. However, such manual approaches are often time consuming and rely on trial-and-error. Indeed, such manual approaches may arbitrarily break up the clock network and may impact the overall placement of components within the PLD due to various design constraints on the positions of such components in the PLD. As a result, PLD performance may suffer.

Accordingly, there is a need for an improved approach to performing clock assignments in a PLD.

### BRIEF DESCRIPTION OF THE DRAWINGS

FIG. 1 illustrates a block diagram of a programmable logic device (PLD) in accordance with an embodiment of the disclosure.

FIG. 2 illustrates a block diagram of clock resources of a PLD in accordance with an embodiment of the disclosure.

FIG. 3 illustrates a design process for a PLD in accordance with an embodiment of the disclosure.

FIG. 4 illustrates a placement process for a PLD in accordance with an embodiment of the disclosure.

FIG. 5 illustrates a clock violation mitigation process for a PLD in accordance with an embodiment of the disclosure.

FIG. 6 illustrates various clock assignments in a PLD in accordance with an embodiment of the disclosure.

Embodiments of the present invention and their advantages are best understood by referring to the detailed description that follows. It should be appreciated that like reference numerals are used to identify like elements illustrated in one or more of the figures.

### DETAILED DESCRIPTION

In accordance with various embodiments set forth herein, techniques are provided to perform cost-based clock assignments in programmable logic devices (PLDs). In particular, a clock assignment cost may be considered when assigning components (e.g., also referred to as logic elements) of a PLD to implement a design (e.g., during placement operations). For example, when performing component placement using a simulated annealing process, a system cost may be considered which includes the clock assignment cost. As a result, component placement decisions performed by the simulated annealing process may be improved by taking into account the availability of clock resources of the PLD (e.g., the number of available clock signals and/or associated routing resources) and the impact of such placement decisions on the ability of the clock resources to meet design constraints.

Further, during such a simulated annealing process, possible clock assignment violations may be periodically mitigated to reduce the number of clock assignments in regions of a PLD that have more clock assignments than permitted by available clock resources. In some embodiments, such mitigation improves the overall speed of the simulated annealing process. As a result, clock assignment in PLDs may be implemented automatically along with the placement of other PLD components.

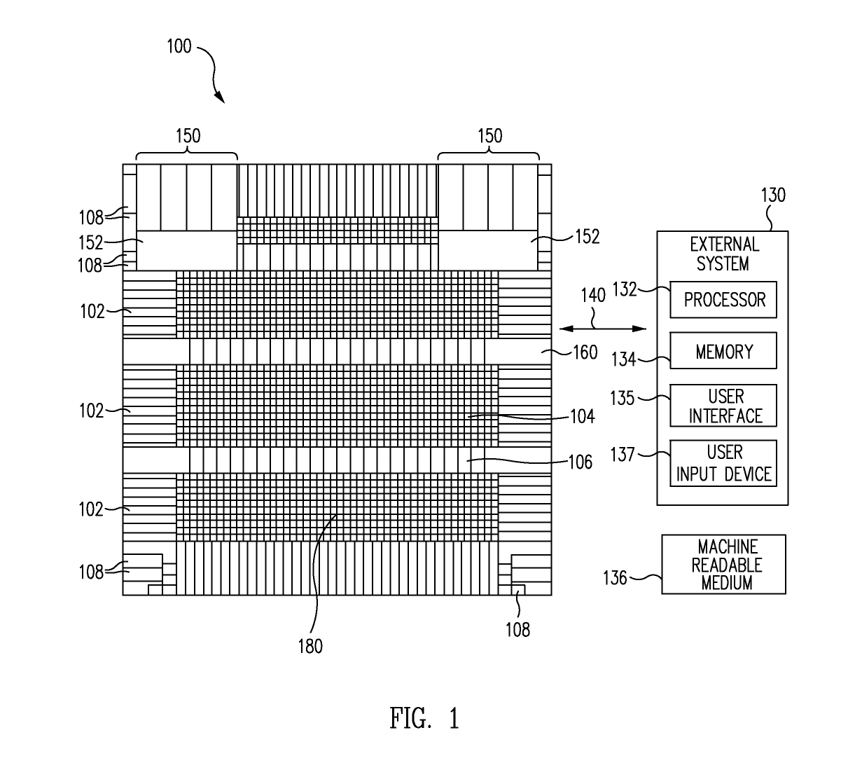

Referring now to the drawings, FIG. 1 illustrates a block diagram of a PLD 100 in accordance with an embodiment of the disclosure. PLD 100 (e.g., a field programmable gate array (FPGA)), a complex programmable logic device (CPLD), a field programmable system on a chip (FPSC), or other type of programmable device) generally includes input/output (I/O) blocks 102 and logic blocks 104 (e.g., also referred to as programmable logic blocks (PLBs), programmable functional units (PFUs), or programmable logic cells (PLCs)).

I/O blocks 102 provide I/O functionality (e.g., to support one or more I/O and/or memory interface standards) for PLD 100, while programmable logic blocks 104 provide logic functionality (e.g., LUT-based logic or logic gate array-based logic) for PLD 100. Additional I/O functionality may be provided by serializer/deserializer (SERDES) blocks 150 and physical coding sublayer (PCS) blocks 152. PLD 100 also includes hard intellectual property core (IP) blocks 160 to provide additional functionality (e.g., substantially predetermined functionality provided in hardware which may be configured with less programming than logic blocks 104).

PLD 100 may also include blocks of memory 106 (e.g., blocks of EEPROM, block SRAM, and/or flash memory), clock-related circuitry 108 (e.g., clock sources, PLL circuits, and/or DLL circuits), and/or various routing resources 180 (e.g., interconnect and appropriate switching logic to provide paths for routing signals throughout PLD 100, such as for clock signals, data signals, or others) as appropriate. In general, the various elements of PLD 100 may be used to perform their intended functions for desired applications, as would be understood by one skilled in the art.

For example, I/O blocks 102 may be used for programming PLD 100, such as logic blocks 104 and memory 106, or transferring information (e.g., various types of data and/or control signals) to/from PLD 100 through various external ports as would be understood by one skilled in the art. I/O blocks 102 may provide a first programming port (which may represent a central processing unit (CPU) port, a peripheral data port, an SPI interface, and/or a sysCONFIG programming port) and/or a second programming port such as a joint test action group (JTAG) port (e.g., by employing standards such as Institute of Electrical and Electronics Engineers (IEEE) 1149.1 or 1532 standards). I/O blocks 102 typically, for example, may be included to receive configuration data and commands (e.g., over one or more connections 140) to configure PLD 100 for its intended use and to support serial or parallel device configuration and information transfer with SERDES blocks 150, PCS blocks 152, hard IP blocks 160, and/or logic blocks 104 as appropriate.

It should be understood that the number and placement of the various elements are not limiting and may depend upon the desired application. For example, various elements may not be required for a desired application or design specification (e.g., for the type of programmable device selected).

Furthermore, it should be understood that the elements are illustrated in block form for clarity and that various elements would typically be distributed throughout PLD 100, such as in and between logic blocks 104, hard IP blocks 160, and routing resources 180 to perform their conventional functions (e.g., storing configuration data that configures PLD 100 or providing interconnect structure within PLD 100). It should also be understood that the various embodiments disclosed herein are not limited to programmable logic devices, such as PLD 100, and may be applied to various other types of programmable devices, as would be understood by one skilled in the art.

An external system 130 may be used to create a desired user configuration or design of PLD 100 and generate corresponding configuration data to program (e.g., configure) PLD 100. For example, external system 130 may provide such configuration data in the form of a bitstream to one or more I/O blocks 102 and/or other portions of PLD 100. As a result, programmable logic blocks 104, routing resources 180, and any other appropriate components of PLD 100 may be configured to operate in accordance with user-specified applications.

In the illustrated embodiment, external system 130 is implemented as a computer system which may be used to perform various computer-implemented methods. In this regard, external system 130 includes, for example, one or more processors 132 which may be configured to execute instructions, such as software instructions, provided in one or more memories 134 and/or stored in non-transitory form in one or more non-transitory machine readable mediums 136 (e.g., which may be internal or external to system 130). For example, in some embodiments, external system 130 may run PLD configuration software, such as Lattice Diamond System Planner software available from Lattice Semiconductor Corporation of Hillsboro, Oreg. to permit a user to create a desired configuration and generate corresponding configuration data to program PLD 100.

External system 130 also includes, for example, a user interface 135 (e.g., a screen or display) to display information to a user, and one or more user input devices 137 (e.g., a keyboard, mouse, trackball, touchscreen, and/or other device) to receive user commands or design entry to prepare a desired configuration of PLD 100.

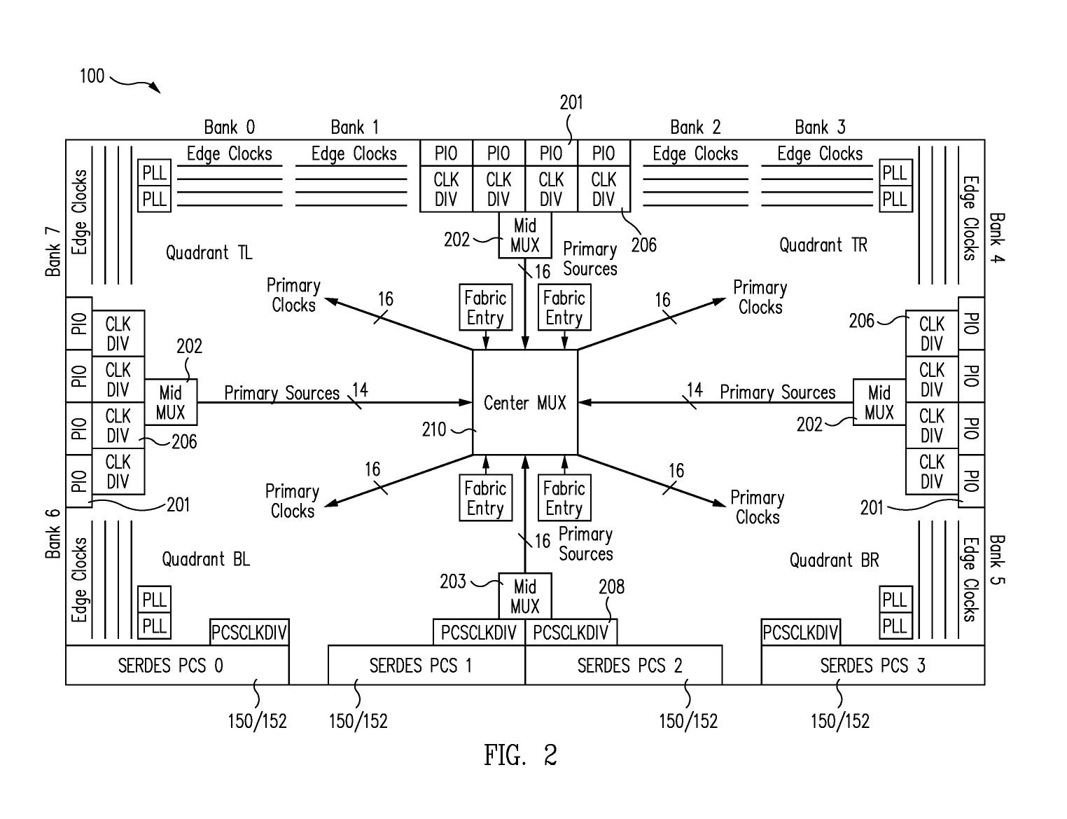

FIG. 2 illustrates a block diagram of clock resources in PLD 100 in accordance with an embodiment of the disclosure. For purposes of clock assignment, PLD 100 may be considered as having a plurality or regions, with each region having an associated clock resource constraint. For example, in the embodiment shown in FIG. 2, PLD 100 may have four regions identified by quadrants: a top-left (TL) quadrant, a top-right (TR) quadrant, a bottom-left (BL) quadrant, and a bottom-right (BR) quadrant. Although PLD 100 will be described in the context of having four quadrants, any desired number of regions and any desired shapes of regions may be used in other embodiments.

Various global clock signals provided by clock-related circuitry 108 of FIG. 1 may be received by interface blocks 201 and passed through clock dividers 206 and multiplexers 202 to provide clock signals to a multiplexer 210 (e.g., 44 Primary Source clock signals in the illustrated embodiment). In addition, data received by SERDES/PCS blocks 150/152 may be passed through clock dividers 208 and multiplexer 203 to provide additional global clock signals to multiplexer 210 (e.g., 16 Primary Source clock signals in the illustrated embodiment).

In some embodiments, multiplexer 210 may be used to selectively pass the received global clock signals to the various quadrants of PLD 100 (e.g., identified as Primary Clock signals in the illustrated embodiment) over appropriate routing resources 180 of PLD 100 (identified in FIG. 1). In this regard, multiplexer 210 may interface with routing resources 180 to distribute global clock signals to various regions of PLD 100 in an organized manner from a single location. In some embodiments, multiplexer 210 may be positioned at a substantially central physical location within PLD 100.

In the illustrated embodiment, multiplexer 210 may receive 60 clock signals and may distribute up to 16 global clock signals to each quadrant of PLD 100. As such, each quadrant of PLD 100 may support a maximum of 16 clock signals. Different numbers of provided and supported clock signals may be used in other embodiments.

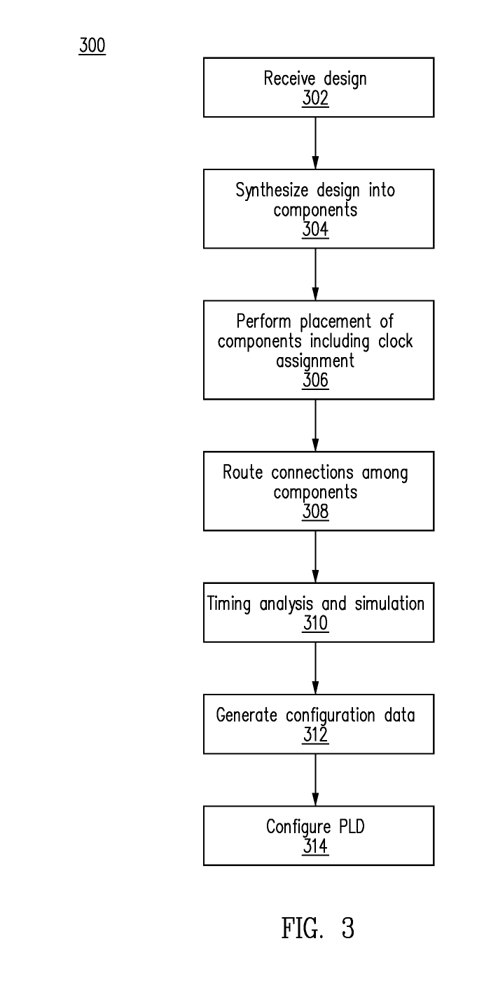

FIG. 3 illustrates a design process 300 for PLD 100 in accordance with an embodiment of the disclosure. For example, the process of FIG. 3 may be performed by external system 130 running Lattice Diamond software to configure PLD 100.

In operation 302, external system 130 receives a design that specifies the desired operation of PLD 100. For example, a user may interact with external system 130 (e.g., through user input device 137 and hardware description language (HDL) code representing the design) to identify various features of the design (e.g., high level logic operations, hardware configurations, and/or other features). External system 130 may perform one or more rule checks to confirm that the design describes a valid configuration of PLD 100. For example, external system 130 may reject invalid configurations and/or request the user to provide new design information as appropriate.

In operation 304, external system 130 synthesizes the design into a set of components of PLD 100 (e.g., logic blocks, embedded hardware, and/or other portions of PLD 100 used to implement the design) that may be used to implement the design. For example, external system 130 may provide a netlist that identifies the components and connections therebetween.

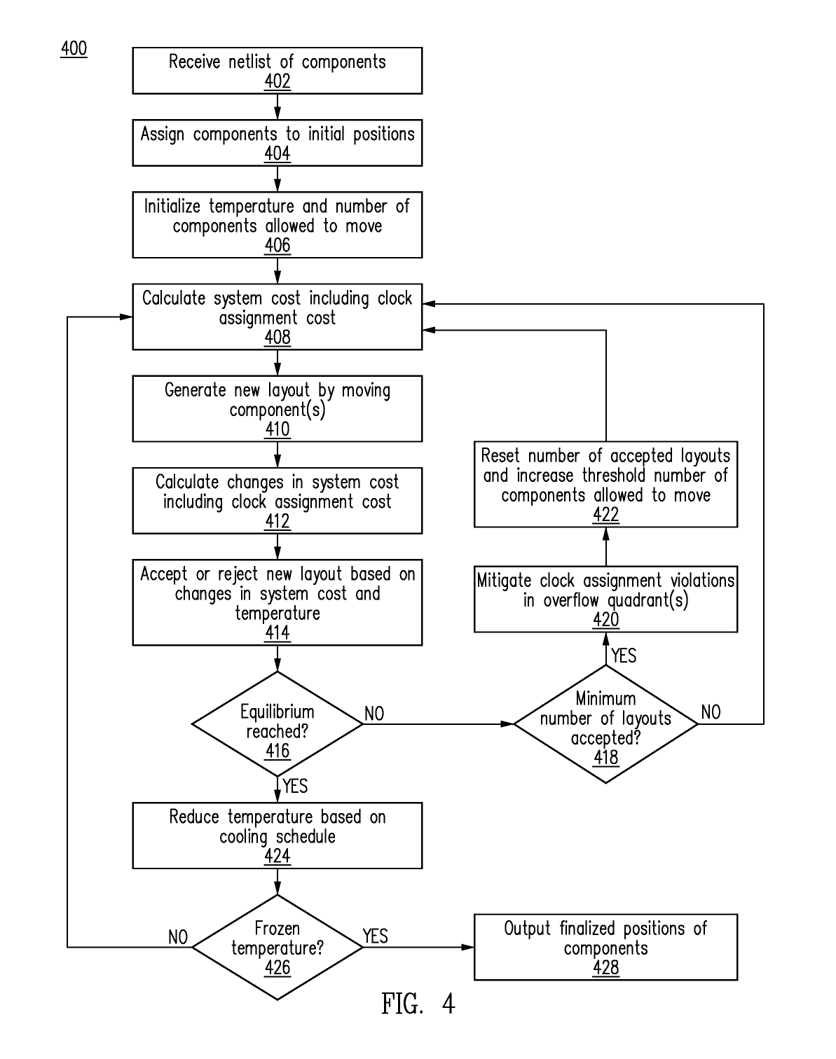

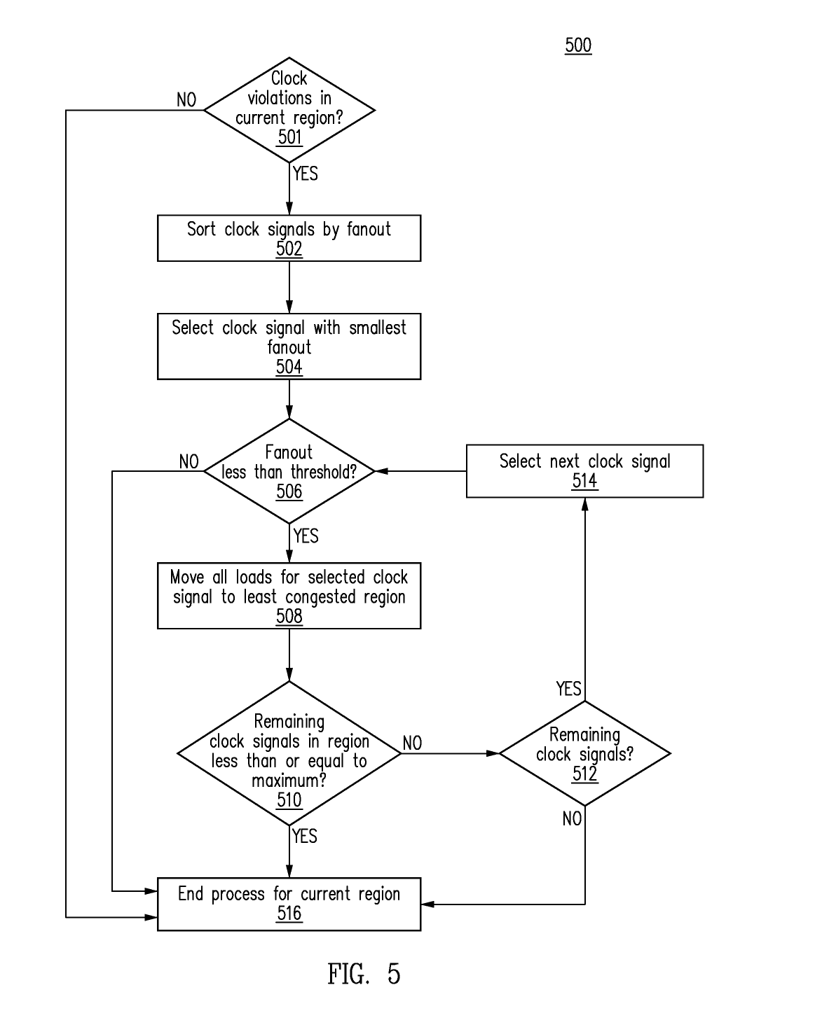

In operation 306, external system 130 performs a placement process to assign the identified set of components to physical components at particular physical locations of the PLD 100. As further described herein with regard to FIGS. 4-5, the placement process may perform a simulated annealing process that considers various factors, including a clock assignment cost.

In operation 308, external system 130 routes connections among the components of PLD 100 based on the placement layout determined in operation 306 (e.g., using routing resources 180) to realize the physical interconnections among the placed components.

In operation 310, external system 130 performs a timing analysis and simulation of the final layout. Thus, the quality and performance of the placed-and-routed design may be determined. External system 130 may display results of the analysis and simulation to the user (e.g., on user interface 135), and the user may confirm the final results of the design.

In operation 312, external system 130 generates configuration data 312 for the placed-and-routed design. In operation 314, external system 130 configures PLD 100 with the configuration data such as, for example, loading a configuration data bitstream into PLD 100 over connection 140.

FIG. 4 illustrates a placement process 400 for PLD 100 in accordance with an embodiment of the disclosure. In some embodiments, placement process 400 may be performed during block 306 of process 300. Placement process 400 may be executed by external system 130 to determine the placement (e.g., layout) of particular physical components of PLD 100 used to implement a design. In particular, placement process 400 may be a simulated annealing process in which various component placements may be simulated to determine their feasibility and compare performance.

In general, the simulated annealing process of FIG. 4 may be performed by iteratively changing (e.g., moving, swapping, or otherwise selecting) the placements of one or more components (e.g., changing the particular physical components assigned to implement the components specified by the netlist). In some embodiments, such placements may be randomly changed. As further described herein, a system cost may be calculated for each layout, and the system costs associated with different layouts may be compared to evaluate whether to keep a new layout (e.g., including the recently changed placements) or revert to a previous layout. In this regard, the simulated annealing process of FIG. 4 may be performed to determine a layout that has a reduced system cost.

In operation 402, external system 130 receives a netlist of components in response to operation 304 of FIG. 3. As discussed, in operation 304, the user's design may be synthesized into a set of components of PLD 100 identified in a netlist.

In operation 404, external system 130 generates an initial placement layout. In particular, the components specified in the netlist may be assigned to initial positions in PLD 100 (e.g., particular physical components of PLD 100 may be selected to implement the synthesized design). In various embodiments, the initial positions may be determined randomly, sequentially based on how the design was created, or otherwise as appropriate.

In operation 406, external system 130 sets an initial value for a temperature T of the simulated annealing process. In accordance with simulated annealing techniques, the temperature may be used to identify the process' current tolerance for accepting layout changes. For example, while the temperature is high, the simulated annealing process will tolerate (e.g., accept) layout changes that may result in a wide range of performance improvements, or even reduced performance, as determined by the calculated system cost. However, as the temperature decreases (e.g., based on a cooling schedule in accordance with simulated annealing techniques), the simulated annealing process will apply more stringent criteria to accept any layout changes. For example, for lower temperatures, layout changes may be required to result in increased performance that exceeds appropriate thresholds (e.g., a minimum system cost reduction may be required before a layout change is accepted). Moreover, the cooling schedule may be adjusted based on how fast or how many iterations are desired in the simulated annealing process.

Also in operation 406, external system 130 initializes a threshold value H. The threshold value may indicate a maximum number of components that may be moved (e.g., reassigned to different physical positions) during a clock violation mitigation process performed in subsequent operation 420 as further described herein.

In operation 408, external system 130 calculates a system cost for the initial layout. In some embodiments, the system cost may be calculated by a system cost function including various factors, such as a total wire length modeled by half perimeters (e.g., a bounding box), timing performance, component congestion, and/or other factors.

For example, it is desirable in some embodiments to shorten the total wire length to reduce signal delays and conserve routing resources. Also, in some embodiments, it is desirable to reduce clock signal propagation time to improve circuit performance and reduce the likelihood of timing violations. In addition, in some embodiments, it is desirable to reduce the congestion (e.g., crowding and density) among placed components to improve the ability of PLD 100 to successfully route signals among components without exhausting routing resources in regions of high component density. Accordingly, by considering these and/or other factors in the system cost, the process of FIG. 4 may operate to reduce the effects of such factors in component layouts.

The system cost function also may include a clock assignment cost. In particular, the clock assignment cost may indicate the number of clock assignments in each region (e.g., each quadrant in the example of FIG. 2) of the PLD 100. Thus, the effects of different layouts on clock assignments may be incorporated into the system cost function when evaluating different layouts.

In some embodiments, the clock assignment cost may be calculated based on the number of clock assignments that exceed the maximum number of clock assignments allowed in each region of PLD 100. For example, as discussed, PLD 100 may be considered as having four quadrants, each of which may support a maximum number of clock assignments (e.g., 16 Primary Clock signals shown in FIG. 2). A clock assignment cost may be determined for each quadrant (CA_cost_{—} quadrant), and may correspond to the number of clock signals assigned to the quadrant that exceed the maximum number of clock assignments as determined by the following equation 1:

CA_cost_quadrant(i)=Wi×MAX((#clocks in quadrant(i)−X),0) (equation 1)

In equation 1, i is the quadrant number, X is the maximum number of clock assignments allowed in each quadrant, and MAX (a, b) returns the larger value between a and b. Thus, a clock assignment cost may be calculated for each quadrant based on the number of clock assignments that exceeds the maximum number allowed in each quadrant, (e.g., the number of clock assignments that are in violation in each quadrant).

Wi is a coefficient used to scale the ratio of the clock assignment cost relative to the overall system cost. For example, a larger Wi value may indicate that the clock assignment cost has greater weight in determining the overall system cost, while a smaller Wi value may that indicate that the clock assignment cost has less weight in the overall system cost. Accordingly, the Wi value may be adjusted based on how important clock assignment is within the overall design of the circuit layout.

The total clock assignment cost (Total ACA cost) may be a sum of the clock assignment cost of all regions. For example, for PLD 100 with four quadrants, the total clock assignment cost may be calculated using the following equation 2:

Total ACA cost=sum of four CA_cost_quadrant(q), where q=[TL,TR,BL,BR] (equation 2)

Thus, the total clock assignment cost (e.g., used as part of the system cost) may be the total number of excess clock assignments (e.g., violations) across all four quadrants of PLD 100.

In operation 410, external system 130 generates a new layout by changing the placement (e.g., assigned positions) of one or more components used by the synthesized design. For example, in some embodiments, a number of components may be randomly selected and moved to different quadrants. As a result, the clock assignments associated with these moved components may also be moved to the different quadrants in the new layout.

In operation 412, external system 130 calculates a new system cost associated with the new layout and determines the change in system cost over the previous layout (e.g., over the previous system cost calculated in operation 408). For example, the system cost may be calculated using a cost function as described with regard to operation 408. In this regard, the changes in clock assignments resulting from the moved components may contribute to an increase or decrease in the clock assignment cost, and consequently, may contribute to a change in the new system cost over the previous system cost.

In operation 414, external system 130 determines whether the new layout should be accepted based on the change in the system cost and the current temperature of the simulated annealing process. If the new layout is accepted, then the new assigned positions of the components moved in operation 410 will be retained. If the new layout is not accepted, then the previously assigned positions will be retained.

As discussed, the current temperature of the simulated annealing process may identify the process' current tolerance for accepting layout changes. Accordingly, while the temperature is high, the new layout may be accepted even if the new layout exhibits an increased system cost (e.g., within a range of permissible system cost increases associated with the current temperature). For example, if the system cost of the previous layout has a value of 150, and the system cost of the new layout is 165 (e.g., indicating reduced performance), then the new layout may still be accepted if the permissible system cost increase associated with the current temperature has a value of 20.

In operation 416, external system 130 determines whether equilibrium has been reached for the current temperature of the simulated annealing process. For example, a number of simulated layouts may be allotted for each temperature, and external system 130 may determine that equilibrium has been reached when the number of simulated layouts has been performed. If equilibrium has been reached, then the simulated annealing process continues to operation 418. Otherwise, the process continues to operation 424.

A loop including operations 418, 420, and 422 may be performed to further adjust the performance of the simulated annealing process. In operation 418, external system 130 determines whether at least a minimum number (e.g., a number K) of new layouts have been accepted (e.g., during multiple iterations of operation 414). If so, the process continues to operation 420. Accordingly, small values of K will permit operation 420 to be performed more frequently. Otherwise, the process returns to operation 408 where the system cost for the current layout is calculated (if desired) and continues through operations 410, 412, 414, and 416 for another new layout.

In operation 420, external system 130 moves components between regions (e.g., adjusts their placement to different quadrants) of PLD 100 in a non-random manner to intentionally reduce or remove (e.g., mitigate) excess clock assignments (e.g., clock assignment violations) in a manner referred to as mitigation (e.g., also referred to as legalization).

In this regard, FIG. 5 illustrates a clock violation mitigation process 500 for PLD 100 in accordance with an embodiment of the disclosure. For example, the process of FIG. 5 may be performed for each region (e.g., quadrant) of PLD 100 during operation 420 of FIG. 4.

In operation 501, external system 130 determines whether the current layout results in any clock assignment violations in the current region (e.g., a selected one of the quadrants). For example, in some embodiments, a clock violation may occur if too many clock signals are assigned to the current region. In this regard, the routing resources 180 associated with the current region may be unable to distribute the number of assigned clock signals. If so, the process continues to operation 502. Otherwise, the process ends for the current region at operation 516.

In operation 502, external system 130 sorts the clock signal assignments for the current region by fanout in ascending order. In this regard, in some embodiments, the relative fanouts of various clock signals may generally correlate with the relative numbers of components supported by the assigned clock signal.

In operation 504, external system 130 selects the clock signal with the smallest fanout. In operation 506, external system 130 determines whether the fanout of the currently selected clock signal (e.g., the number of components of PLD 100 in the current region that receive the clock signal) is less than the threshold value H (e.g., previously initialized in operation 406 of FIG. 4). As further described herein, the threshold value H may be adjusted to permit larger numbers of components to be moved during the process of FIG. 5. If the fanout of the current clock signal is less than the threshold value H, then the process continues to operation 508. Otherwise, the process ends for the current region at operation 516. As further described herein, the threshold value may be increased in operation 422 of FIG. 4 which can permit subsequent iterations of the mitigation process of FIG. 5 to consider larger fanouts. Thus, clock violations corresponding to larger fanouts that are not handled in one iteration of the mitigation process of FIG. 5, and are not otherwise handled by the simulated annealing process of FIG. 4, may be handled in a subsequent iteration of FIG. 5.

In operation 508, external system 130 moves all components associated with the currently selected clock signal from their currently assigned region to the least congested region (e.g., the region having the lowest number of clock assignments). Thus, this effectively also moves the currently selected clock signal from the currently selected region to the least congested region to reduce the clock resources utilized in the currently selected region.

In operation 510, external system 130 determines whether the number of clock signals remaining in the current region is less than or equal to the maximum number allowed by resources of PLD 100 for the current region. If so, the process ends for the current region in step 516, because all excess clock assignments (e.g., violations) have been mitigated. If there remain clock assignments in excess of the maximum allowed number, external system 130 determines (operation 512) whether there are any clock signals assigned to the current region that have not yet been considered in the process of FIG. 5. If not, the process ends in operation 516 for the current region. As discussed, clock violations that are not considered by the current iteration of the process of FIG. 5 (e.g., due to fanout) may be subsequently handled by the processes of FIGS. 4 and 5. Otherwise, external system 130 selects the next clock signal in the sorted list (operation 514) to continue the mitigation process.

The various operations of FIG. 5 may be iteratively performed for the clock signals assigned to each region. As a result, clock signals and their associated components which exceed the available clock resources for a given region may be proactively assigned to a less congested region (e.g., for signals having a fanout less than threshold value H). This is addition to the other layout changes performed in operation 410 (e.g., performed by the simulated annealing process of FIG. 4) as previously discussed.

In some embodiments, the process of FIG. 5 may be implemented by the following pseudo code:

For each quadrant Q in [TL,TR,BL,BR] with more than X clocks
{

Sort the clocks in quadrant Q per fanout in Q in ascending
order, save results in storage ‘sorted_clk’
while ‘sorted_clk’ is not empty, select signal ‘S’ from the
front of sorted_clk
{

If ( fanout of ‘S’ < threshold ‘H ‘)
{
relocate loads of ‘S’ in quadrant Q to a least congested
quadrant Q′
delete ‘S’ from ‘sorted_clk’
update clock info in in Q and Q′
If (#clocks in Q <= X) break while loop;
}

}

}

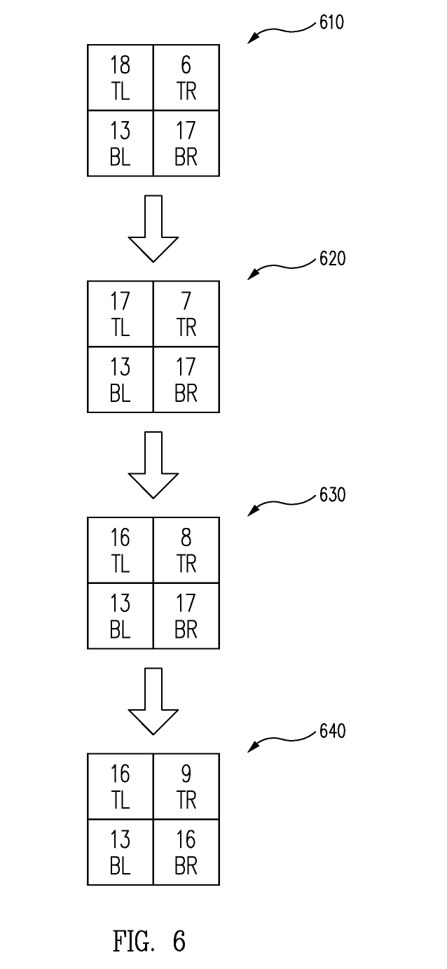

FIG. 6 illustrates various clock assignments adjusted during successive iterations of operations in process 500 in accordance with an embodiment of the disclosure. In particular, four different clock assignment arrangements 610, 620, 630, and 640 are shown for quadrants TL, TR, BL, and BR of PLD 100.

In the initial arrangement 610, quadrant TL has 18 assigned clock signals, quadrant TR has 6 assigned clock signals, quadrant BL has 13 assigned clock signals, and quadrant BR has 17 assigned clock signals.

Assuming that clock resources of each quadrant may support up to a maximum of 16 clock signals, there are clock assignment violations in quadrants TL and BR in arrangement 610. As such, starting from quadrant TL, external system 130 moves one clock signal from quadrant TL to quadrant TR, which is the quadrant with the least number of clock signal assignments. As shown in arrangement 620, quadrant TL now has 17 clock signal assignments and quadrant TR now has 7 clock signal assignments.

In arrangement 620, quadrant TL still has one excess clock signal assignment which has to be mitigated or corrected. External system 130 again moves one clock signal assignment from quadrant TL to quadrant TR, which is the quadrant with the least number of clock signal assignments. As shown in arrangement 630, quadrant TL now has 16 clock signal assignments and quadrant TR now has 8 clock signal assignments.

In arrangement 630, quadrant TL no longer has excess clock signal assignments. Quadrant BR, however, has one excess clock signal assignment. As such, external system 130 moves one clock signal assignment from quadrant BR to quadrant TR, which has the least amount of clock signal assignments. As shown in arrangement 640, quadrant BR now has 16 clock signal assignments and quadrant TR now has 9 clock signal assignments. In arrangement 640, each quadrant has a proper number of clock signal assignments that do not exceed clock resources of PLD 100.

Referring back to FIG. 4, after the mitigation process of operation 420, external system 130 resets the number of accepted new layouts and increases the value of threshold value H in operation 422. For example, the number of accepted new layouts may be reset to zero, such that a new cycle of simulations may be performed before the mitigation process is performed again to correct violations in clock assignments.

Further, increasing the threshold value H in operation 422 permits greater numbers of components (e.g., loads corresponding to clock signal fanouts) to be moved during the mitigation process of operation 420. For example, in some embodiments, the threshold value H may be doubled for each iteration of operation 422. As a result, external system 130 may operate to reposition increasing numbers of components and associated clock signals to different regions of PLD 100 during the mitigation process of FIG. 5 as the simulated annealing process of FIG. 4 continues (e.g., to proactively move increasing numbers of components if clock resource constraints are not met as the simulated annealing process continues). Following operation 422, the process of FIG. 4 returns to operation 408 to continue the simulation for the next new layout.

Referring again to operation 416, if equilibrium has been reached for the current temperature (e.g., in accordance with simulated annealing principles), the current temperature is reduced at operation 424 based on a cooling schedule of the simulated annealing process. In some embodiments, a predetermined number of simulations may be performed for each temperature. The cooling schedule may gradually reduce the temperature over time, such that the tolerance for accepting new layouts that result in increased system costs may decrease over time.

In operation 426, external system 130 determines whether the current temperature has reached a frozen temperature for the simulated annealing process. For example, based on the cooling schedule, a frozen temperature may be set at which the simulation process may be finished. If the frozen temperature is not reached, the process returns to operation 408 to continue simulation under a new temperature. If the frozen temperature is reached, external system 130 accepts the current layout as the finalized positions of the components of PLD 100 and accordingly provides an output (e.g., a file or other data representation) of the layout in operation 428 (e.g., for use by routing operation 308 of FIG. 3).

In view of the above discussion, it will be appreciated that the simulated annealing techniques described herein may be used to consider clock resource constraints as part of the overall system cost, resulting in improved results and ease of implementation over conventional manual clock signal assignments (e.g., shorter total wire length, increased performance, less congestion, and/or improved clock signal assignments). Moreover, the mitigation techniques described herein may be used to supplement such simulated annealing techniques to proactively reduce clock signal assignment violations with minimal perturbation.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more non-transitory machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A computer-implemented method comprising:
receiving a design identifying operations to be performed by a programmable logic device (PLD);
synthesizing the design into a plurality of components of the PLD configured to perform the operations; and
performing a simulated annealing process to determine a layout of the components in the PLD based on a system cost including a clock assignment cost for global clock signals of the PLD.

2. The computer-implemented method of claim 1, wherein the simulated annealing process comprises:
generating a new layout of the components by changing positions of at least a subset of the components;
calculating changes in the system cost including changes to the clock assignment cost resulting from the changed positions; and
selectively accepting the new layout based on the changes in the system cost including the changes to the clock assignment cost and a temperature of the simulated annealing process.

3. The computer-implemented method of claim 2, further comprising repeating the generating, the calculating, and the accepting in accordance with a cooling schedule of the simulated annealing process.

4. The computer-implemented method of claim 1, further comprising selectively performing a clock violation mitigation process during the simulated annealing process.

5. The computer-implemented method of claim 4, wherein the clock violation mitigation process comprises:
selecting one of the global clock signals associated with a clock assignment violation in a first region of the PLD;
generating a new layout by changing positions of the components associated with the selected global clock signal from the first region of the PLD to a second region of the PLD.

6. The computer-implemented method of claim 5, wherein the selecting one of the global clock signals comprises selecting one of the global clock signals associated with less than a maximum number of associated components.

7. The computer-implemented method of claim 6, further comprising:
increasing the maximum number; and
repeating the clock violation mitigation process using the increased maximum number.

8. The computer-implemented method of claim 4, wherein the performance of the clock violation mitigation process is conditioned on a minimum number of new layouts being accepted by the simulated annealing process.

9. The computer-implemented method of claim 1, wherein the clock assignment cost is calculated based on a number of clock assignment violations in each of a plurality of regions of the PLD, wherein each region has a finite number of assignable clock resources.

10. The computer-implemented method of claim 1, wherein the system cost is calculated based on one or more of a wire length, a timing analysis, and a congestion analysis.

11. A system comprising:
a processor; and
a memory adapted to store a plurality of computer readable instructions which when executed by the processor are adapted to cause the system to perform a computer-implemented method comprising:
receiving a design identifying operations to be performed by a programmable logic device (PLD),
synthesizing the design into a plurality of components of the PLD configured to perform the operations, and
performing a simulated annealing process to determine a layout of the components in the PLD based on a system cost including a clock assignment cost for global clock signals of the PLD.

12. The system of claim 11, wherein the simulated annealing process comprises:
generating a new layout of the components by changing positions of at least a subset of the components;
calculating changes in the system cost including changes to the clock assignment cost resulting from the changed positions; and
selectively accepting the new layout based on the changes in the system cost including the changes to the clock assignment cost and a temperature of the simulated annealing process.

13. The system of claim 12, wherein the simulated annealing process further comprises repeating the generating, the calculating, and the accepting in accordance with a cooling schedule.

14. The system of claim 11, wherein the computer-implemented method further comprises selectively performing a clock violation mitigation process during the simulated annealing process.

15. The system of claim 14, wherein the clock violation mitigation process comprises:
selecting one of the global clock signals associated with a clock assignment violation in a first region of the PLD; and
generating a new layout by changing positions of the components associated with the selected global clock signal from the first region of the PLD to a second region of the PLD.

16. The system of claim 15, wherein the selecting one of the global clock signals comprises selecting a clock signal associated with less than a maximum number of associated components.

17. The system of claim 16, wherein the clock violation mitigation process further comprises:
increasing the maximum number; and
repeating the clock violation mitigation process using the increased maximum number.

18. The system of claim 14, wherein the performance of the clock violation mitigation process is conditioned on a minimum number of new layouts being accepted by the simulated annealing process.

19. The system of claim 11, wherein the clock assignment cost is calculated based on a number of clock assignment violations in each of a plurality of regions of the PLD, wherein each region has a finite number of assignable clock resources.

20. A non-transitory machine-readable medium storing a plurality of machine-readable instructions which when executed by one or more processors of a computer system are adapted to cause the computer system to perform a computer-implemented method comprising:
receiving a design identifying operations to be performed by a programmable logic device (PLD);
synthesizing the design into a plurality of components of the PLD configured to perform the operations; and
performing a simulated annealing process to determine a layout of the components in the PLD based on a system cost including a clock assignment cost for global clock signals of the PLD.
